(19) United States
(12) Patent Application Publication
(10) Pub. No.: US 2011/0013772 A1
(43) Pub. Date: Jan. 20, 2011

(54) Method and Apparatus for Fast Switching Between Source Multimedia Devices

(75) Inventors: Wolfgang ROETHIG, San Jose, CA (US); Evgeny ROYZEN, Kiriat Ono (IL)

Correspondence Address: MYERS WOLIN, LLC, 100 HEADQUARTERS PLAZA, North Tower, 6th Floor, MORRISTOWN, NJ, 07960-6834, US

(73) Assignee: TRANSWITCH CORPORATION, Shelton, CT (US)

(21) Appl. No.: 12/505,806

(22) Filed: Jul. 20, 2009

(51) Int. Cl. H04N 7/167

(52) U.S. Cl. 380/200

(57) ABSTRACT

A multimedia sink apparatus and method thereof, for fast switching between a plurality of source multimedia devices. The apparatus comprises a plurality of input ports, each of the plurality of input ports is connected to a source multimedia device through a high bandwidth multimedia interface; and a plurality of high-bandwidth digital content protection (HDCP) receivers, each of the plurality of the HDCP receivers is connected to an input port, wherein each of the plurality of the HDCP receivers is adapted to perform a first authentication part of a HDCP authentication process, and upon reception of an indication that a respective source device connected to the respective input was selected, to perform a third authentication part of the HDCP authentication process.

### TECHNICAL FIELD

This invention generally relates to connectivity of multimedia devices.

### BACKGROUND OF THE INVENTION

High bandwidth multimedia interfaces, such as the high-definition multimedia interface (HDMI™), digital visual interface (DVI), DisplayPort and the like are licensable compact audio/video interfaces for transmitting uncompressed digital streams. Such interfaces typically connect a multimedia source device (e.g., a set-top box, a DVD player, a personal computer, a video game console, etc.) to a compatible multimedia sink device, such as a digital television. In contrast to consumer analog audio/video interfaces, the high bandwidth multimedia interfaces enforce digital rights management (DRM) on transmitted media.

Data protection is achieved using a high-bandwidth digital content protection (HDCP) system which is fully described in the HDCP Specification version 1.3 published on Dec. 26, 2006, incorporated herein by reference in its entirety merely for the useful understanding of the background of the invention.

The HDCP authentication protocol facilitates a hand-shake process between a HDCP transmitter and a HDCP receiver that affirms to the HDCP transmitter that the HDCP receiver is authorized to receive HDCP contents. The HDCP transmitter is part of a multimedia source device and the HDCP receiver is part of the multimedia sink device. In the HDMI and DVI interfaces the HDCP authentication is initiated when a hop-plug detected (HPD) signal is triggered by the sink device.

FIG. 1 shows a flowchart 100 describing the HDCP flow between a HDCP transmitter and receiver. At S110, the HDCP receiver asserts a HPD signal when a source device is connected to the sink device. At S115, after detection of the HPD signal, the HDCP transmitter reads the Enhanced Extended Display Identification Data (E-EDID) from the HDCP receiver. The E-EDID specifies, at least, the capabilities of the sink device, e.g., if the device is HDMI compatible. The transfer time of the E-EDID data is less than 100 milliseconds (msec). The E-EDID information is saved in the source device.

The HDCP authentication includes three parts, all initiated by the HDCP transmitter, and each part has a different completion time. At S120 the first authentication part is triggered by sending to the receiver an initiation message containing the transmitter's key selection vector (KSV) value (Aksv) and a pseudo-random value (An). In addition, the transmitter reads the receiver's KSV value (Bksv). While the data is being transferred, the transmitter computes a shared secret value (Kₘ), a secret value used during the second authentication part (M₀), and a response value (R₀). At S125 the receiver computes its shared secret value (K′ₘ), a secret value used during the second authentication part (M′₀), and a response value (R′₀). The values Aksv, Bksv, Kₘ and K′ₘ are stored in the memory. The values R₀, R′₀, M₀, and M′₀ are session based.

The response value R′₀ computed by the receiver must be ready to be read within 100 msec. The R₀ and R′₀ values are used to determine if the first authentication part was successful. At S130, the transmitter reads the R′₀ from the receiver at least 100 msec after sending the Aksv value, and further checks if its response value R₀ equals to the receiver response value R′₀, and if so the first authentication was successful and execution continues with S135; otherwise, it is determined that the authentication failed and execution returns to an initial state (S105).

At S135, it is checked if the multimedia sink device is a repeater (e.g., a video processor, an audio amplifier, etc.), and if so execution continues with S140; otherwise, execution proceeds to the third authentication part at S155. At S140 and S145 the second authentication part is performed only if the HDCP receiver is a HDCP repeater. Specifically, at S140 the HDCP transmitter reads a list of KSVs from a KSV FIFO data structure maintained by the HDCP repeater, computes a hash value V, and reads the repeater's hash value V′. The value V′ is computed by the HDCP repeater, at S145, in response to the second authentication part initiated by the HDCP transmitter. The hash values V and V′ are the hash values of the concatenation of the KSVs in the list of KSVs. At S150, the transmitter checks if the values V and V′ are equal, and if so, the second authentication part was successful and execution continues with S155; otherwise, it is determined that the authentication failed and execution returns to the initial state at S105. The time required to complete the second authentication part is about 5 seconds, mainly due to the time required by the receiver to assemble the KSV FIFO.

At S155, the third authentication part is triggered every 2 seconds, which is the time between 128 video frames. The third authentication part provides link verification and is performed as long as the link between a source and sink is active. Typically, this authentication part occurs during the vertical blanking interval preceding a video frame. Every frame, the HDCP transmitter computes a link integrity verification value Rᵢ (i is a frame index). At S160 the HDCP receiver/repeater computes its link integrity verification value R′ᵢ. Subsequently, at S165, it is checked if the verification values Rᵢ and R′ᵢ are equal, and if so the third authentication part was successful and execution returns to S155, where this authentication part is repeated every 2 seconds; otherwise, it is determined if the authentication failed and then execution returns to the initial state at S105. As defined in the HDCP specification, after three failures of the third authentication the execution returns to the initial state S105. In a worst-case scenario, the HDCP link fails immediately after successful link verification, and it takes the HDCP transmitter 2 seconds to detect the link failure. During that time neither the HDCP transmitter nor the receiver knows that the link is broken. Thus, the receiver decrypts and renders data incorrectly, and such data will be displayed as white noise on the screen. Only after return to the initial state S105 the screen will be blank.

The HDCP flow described with reference to FIG. 1 is applied when there is a single source device connected to a sink device. However, a typical multimedia system or network includes multiple multimedia source devices (e.g., a DVD, a setup box, a game console, and the like) connected to a single multimedia sink device (e.g., a TV). In such configuration the sources are physically connected to different ports on the sink device and selection of a specific source is done through, for example, a remote control.

Such configuration requires that a link between each source to the sink would be active to allow instantaneous switching without losing video/audio data. However, this requires having replicated multimedia interface receivers (e.g., a HDMI receiver) at each port at the sink. This is costly solution as multiple receivers are used instead of a single receiver. An alternative approach is to maintain only one active link between a source and the sink. However, this requires performing the HDCP authentication process when switching between different sources. As the authentication takes up to 5 seconds to completion during that time video frames cannot be transmitted and displayed by the sink. In addition, the authentication process can be triggered only by a source device when, it is being selected.

Therefore, it would be advantageous to provide a solution for instantaneous switching between source multimedia devices.

### SUMMARY OF THE INVENTION

Certain embodiments of the invention include a multimedia sink apparatus for fast switching between a plurality of source multimedia devices. The apparatus comprises a plurality of input ports, each of the plurality input ports is connected to a source multimedia device through a high bandwidth multimedia interface; and a plurality of high-bandwidth digital content protection (HDCP) receivers, each of the plurality of the HDCP receivers is connected to an input port, wherein each of the plurality of the HDCP receivers is adapted to perform a first authentication part of a HDCP authentication process, and upon reception of an indication that a respective source device connected to the respective input was selected, to perform a third authentication part of the HDCP authentication process.

Certain embodiments of the invention also include a method for fast switching between a plurality of source multimedia devices connected to a sink multimedia device through a high bandwidth multimedia interface, wherein the method is performed by a HDCP receiver connected to the sink multimedia device. The method comprises asserting a hot-plug detected (HPD) signal; performing a first authentication part of a high-bandwidth digital content protection (HDCP) authentication process; and upon reception of an indication that a source multimedia device connected to the HDCP receiver was selected, performing a third authentication part of the HDCP authentication process.

### BRIEF DESCRIPTION OF THE DRAWINGS

The subject matter that is regarded as the invention is particularly pointed out and distinctly claimed in the claims at the conclusion of the specification. The foregoing and other objects, features and advantages of the invention will be apparent from the following detailed description taken in conjunction with the accompanying drawings.

FIG. 1 is a diagram illustrating a HDCP flow.

FIG. 2 is a block diagram of a multimedia sink device implemented in accordance with an embodiment of the invention.

FIG. 3 is a flowchart describing a method for enabling fast switching between source devices implemented in accordance with an embodiment of the invention.

FIG. 4 is a flowchart describing a method for optimizing the HDCP flow implemented in accordance with an embodiment of the invention.

FIG. 5 is a flowchart describing a method for optimizing the second authentication implemented by a HDCP transmitted in accordance with an embodiment of the invention.

FIG. 6 is a diagram illustrating the TDMA retrieval of E-EDID and DKS information.

### DETAILED DESCRIPTION OF THE INVENTION

It is important to note that the embodiments disclosed by the invention are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

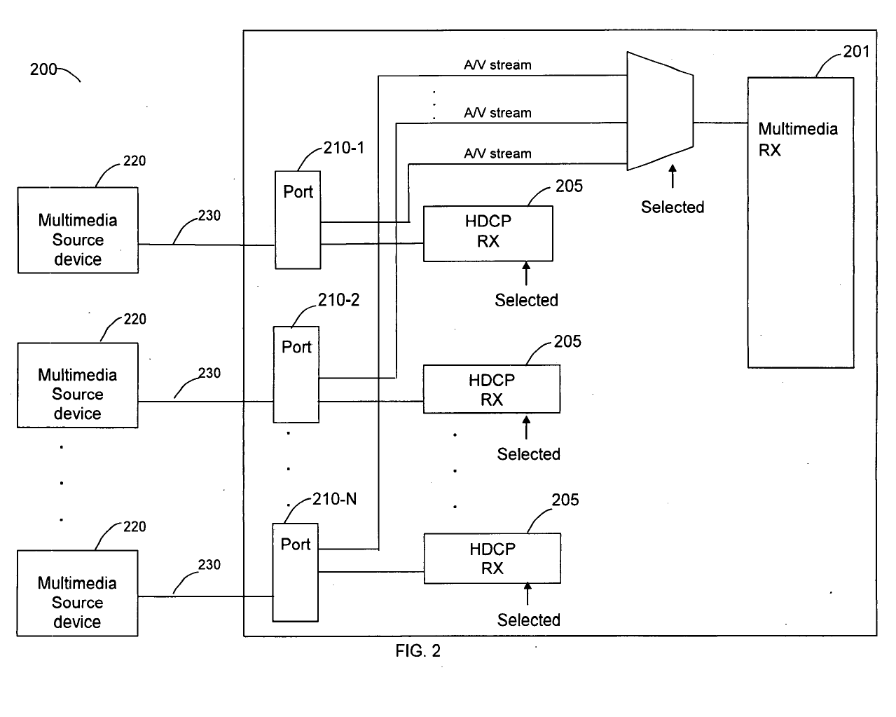

FIG. 2 shows a non-limiting and exemplary block diagram of a multimedia sink apparatus 200 implemented in accordance with an embodiment of the invention. The sink apparatus 200 includes N ports 210-1 through 210-N, each of which is connected to a multimedia source device 220 through a high bandwidth multimedia interface 230. The high bandwidth multimedia interface 230 may be, but is not limited to, a HDMI, a DVI, a DisplayPort, and the like. The sink apparatus 200 includes a multimedia interface receiver 201 compliant with at least one of a HDMI standard, a DVI standard, a DisplayPort standard, or any combination thereof. The receiver 201 performs at least the tasks of enabling the selection of a source device 220, establishing a link with the selected source device 220, receiving video/audio streams, and processing these streams. In a preferred embodiment of the invention the multimedia receiver is a HDMI receiver and the audio/video streams are TMDS streams. Each port 210 is coupled to a HDCP receiver 205 capable of executing a modified HDCP authentication process described in greater detail below, asserting a HPD signal, and de-asserting the HPD signal. Each port 210 receives an indication on whether a respective source device 220 connected therein was selected.

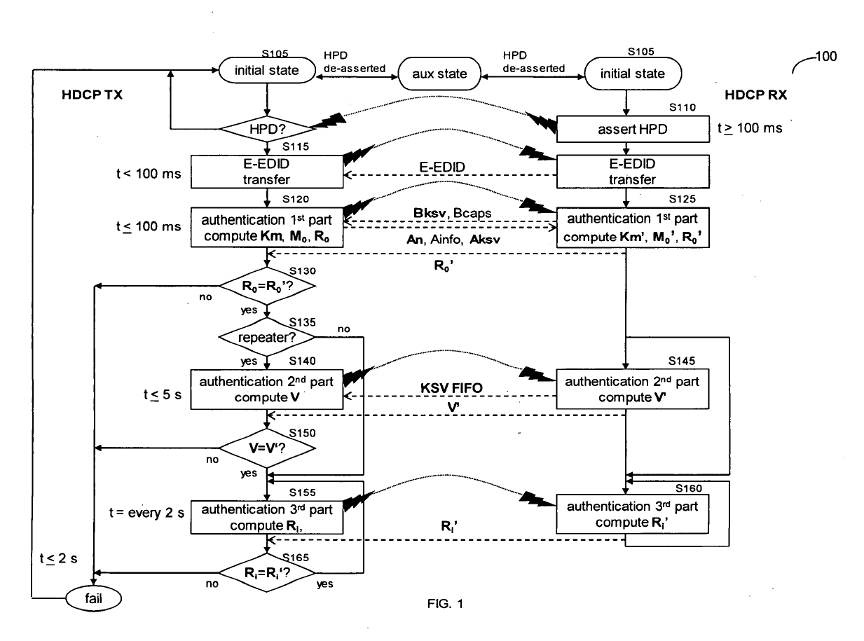

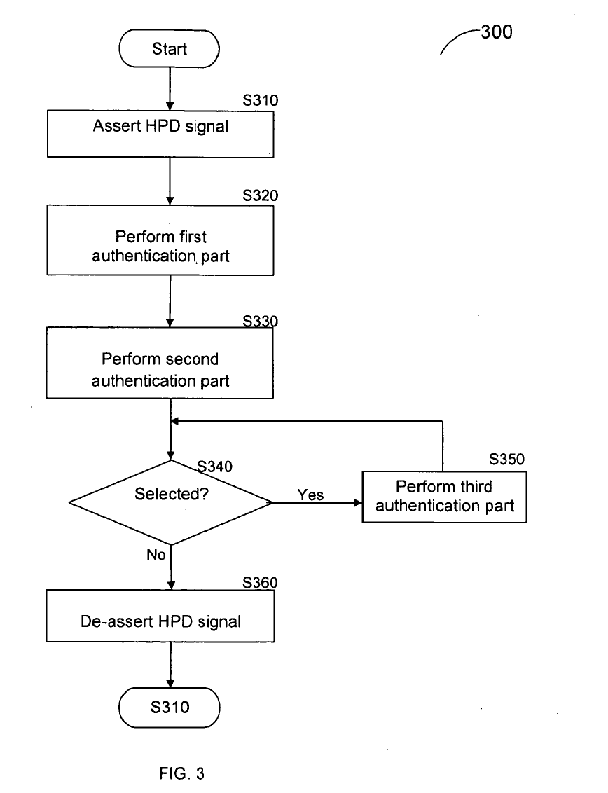

FIG. 3 shows a non-limiting and exemplary flowchart 300 describing the process for enabling fast switching between source devices implemented in accordance with an embodiment of the invention. The process is a modified HDCP flow carried by a HDCP receiver 205 at each port 210 and when executed a source device 220 is on and physically connected to the port 210. In accordance with an embodiment of the invention a HDCP receiver 205 uses the HPD signals to control the HDCP flow. It should be noted that the actions performed by a HDCP transmitter are not shown in FIG. 3, but can be understood from the flow described with reference to FIG. 1.

At S310 a HPD signal is asserted by a HDCP receiver 205 and sent to the HDCP transmitter at the source device 220 which, in response, initiates the first authentication part of the HDCP flow. At S320, the HDCP receiver 205 at the port 210 performs the first authentication part. At S330 if the sink device is a repeater, then the second authentication part is also performed. Steps S320 and S330 are performed as defined in the HDCP standard and described in detail above. At S340 it is checked if a source device 220 connected to the 210 port was selected; and if so execution continues with S350 where the third authentication part is performed; otherwise, at S360 the HPD signal is de-asserted and execution returns to S310. In one embodiment, the execution waits a predefined time (e.g., 100 msec) between de-asserting (at S360) and re-asserting (at S310) the HPD signal.

The HDCP flow is a hand-shake process, thus any authentication part performed by the HDCP receiver 205 is also carried by the HDCP transmitter at the source device 210. Furthermore, the de-assertion of the HPD signal immediately causes the HDCP transmitter, and thereby the HDCP receiver 205, to terminate any authentication action and return to the initial state (105). That is, the HDCP receiver and transmitter will not perform the third authentication part if the source device is not selected. It should be appreciated that a link can be established between the sink device and source device only when the latter is selected. Therefore, the third authentication part (i.e., link verification) will always fail if a source device connected to a respective port is not selected. This results in a waiting time bounded by the interval between subsequent trials of link verification (e.g., 2 seconds) before retrying to authenticate the connection. If the source device is being selected during this waiting time erroneous data (e.g., incorrectly decrypted data, resulting in a snow screen) would be displayed on the sink device and video data would be lost as the link cannot be established. The invention disclosed herein eliminates this waiting time as the third authentication process is performed only upon selection of the source device, thereby enabling fast and instantaneous switching between source devices without losing any video data.

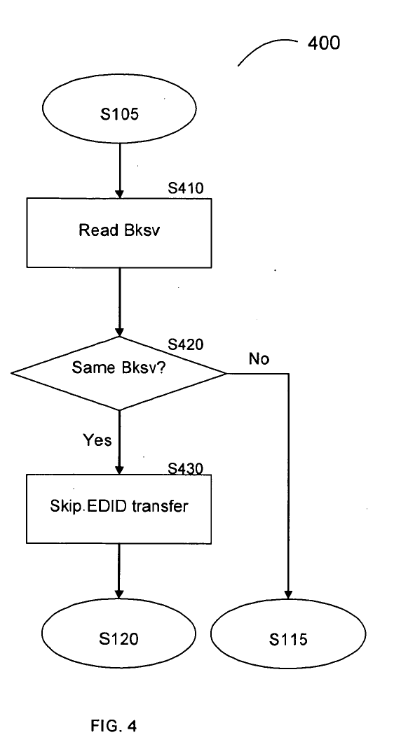

FIG. 4 shows an exemplary and non-limiting flowchart 400 describing the method for optimizing the HDCP flow implemented in accordance with an embodiment of the invention. The method described herein is executed by a HDCP transmitter and allows saving additional time during authentication. At S410 the receiver's KSV value (Bksv) is read by the HDCP receiver. At S420 it is checked if the Bksv is the same as the Bksv value maintained in the HDCP transmitted, and if so, at S430 the HDCP transmitter instructs the HDCP receiver not to transfer the E-EDID information and execution continues with the first authentication part (e.g. S120 shown in FIG. 1); otherwise, the HDCP flow continues with the transfer of the E-EDID information (e.g., S115 shown in FIG. 1). If the Bksv values are equal, a link was previously established between the source and sink devices, and therefore the source knows the capabilities of the sink. The steps S410, S420 and S430 are performed between the steps S105 and S110 of the HDCP flow illustrated in FIG. 1.

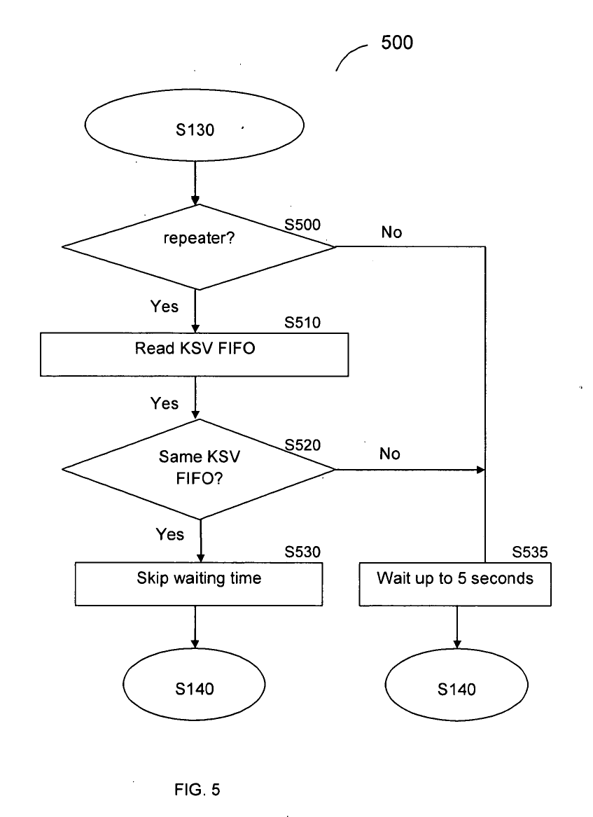

FIG. 5 shows an exemplary and non-limiting flowchart 500 describing the method for optimizing the second authentication implemented by a HDCP transmitted in accordance with an embodiment of the invention. If it is determined at S505 that the sink device is a repeater, then at S510 the transmitter reads the KSV FIFO without waiting for the repeater to assemble the KSV FIFO contents (this waiting time is approximately 5 seconds). At S520 it is checked if the contents of the KSV FIFO are the same as the values saved in the transmitter, and if so the HDCP flow continues with the second authentication part without waiting the time required to assemble the FIFO; otherwise, execution waits, as S535, this time and performs the second authentication part as described in detail above. The steps S510 and S520 would be performed between the steps S135 and S140 of the HDCP flow illustrated in FIG. 1.

In accordance with an embodiment of the invention a time-division multiple access (TDMA) technique is utilized to retrieve E-EDID information and/or device key selection (DKS) information from the memory by multiple HDCP ports. Retrieving such information is required by the HDCP authentication process. According to this embodiment, each HDCP port has a time slot for E-EDID and a time slot for DKS retrieval. Therefore, 2*n time slots are needed for ‘n’ ports (n is an integer number). Each HDCP port accesses the memory only at the time slot allocated for the information retrieval, thereby preventing a conflict due to simultaneous access.

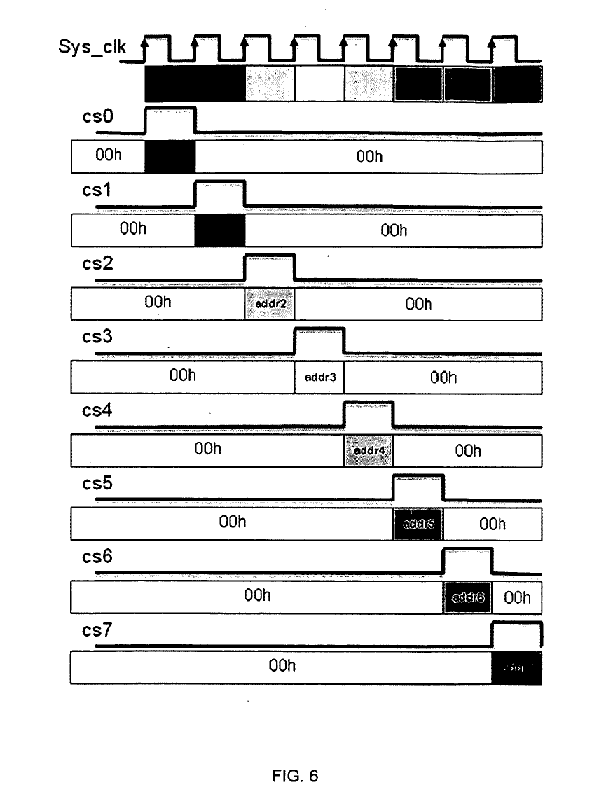

As illustrated in FIG. 6, a sequence of 8 (i.e., n=8) time slots is repeated periodically at a system clock rate. Therefore, each time slot provides bandwidth of ⅛ system clock (Sys_clk) rate. It should be appreciated that this is not a penalty, as the bit rate at the HDCP port is only 400 Kb/sec, which is a significantly low rate in comparison to the system clock rate.

In accordance with another embodiment an inter-integrated circuit (I2C) suspend mechanism is utilized by HDCP ports. In one configuration, a HDCP receiver port is an I2C slave. The I2C protocol requires the slave to send acknowledgment after each transaction. The slave can delay acknowledgments, e.g., by holding the clock, in order to prevent a master from initiating another transaction. An HDCP port can be selected to be the active port at any time. When a port is not selected, the first part of the authentication process is repeated periodically.

According to this embodiment, the slave can run the first authentication part at normal speed at the beginning of the process, and then slow the execution process at the end using the suspend mechanism. This would increase the probability that a port is selected just when the first authentication part is about to be completed, thereby increasing the time saved during switching ports.

The principles of the invention may be implemented in hardware, software, firmware or any combinations thereof. The software may be implemented as an application program tangibly embodied on a program storage unit or computer readable medium. The application program may be uploaded to, and executed by, a machine comprising any suitable architecture, for example a computer platform having hardware such as one or more central processing units (“CPUs”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown.

It is to be further understood that, because some of the constituent system components and methods depicted in the accompanying drawings are preferably implemented in software, the actual connections between the system components or the process function blocks may differ depending upon the manner in which the present invention is programmed. Given the teachings herein, one of ordinary skill in the pertinent art will be able to contemplate these and similar implementations or configurations of the present invention. All examples and conditional language recited herein are intended for pedagogical purposes to aid the reader in understanding the principles of the invention and the concepts contributed by the inventors to furthering the art, and are to be construed as being without limitation to such specifically recited examples and conditions.

All statements herein reciting principles, aspects, and embodiments of the invention, as well as specific examples thereof, are intended to encompass both structural and functional equivalents thereof. It is intended that such equivalents include both currently known equivalents as well as equivalents developed in the future, i.e., any elements developed that perform the same function, regardless of structure. Other hardware, conventional and/or custom, may also be included.

What we claim is:

1. A multimedia sink apparatus for fast switching between a plurality of source multimedia devices, comprising:
a plurality of input ports, each of the plurality input ports is connected to a source multimedia device through a high bandwidth multimedia interface; and
a plurality of high-bandwidth digital content protection (HDCP) receivers, each of the plurality of the HDCP receivers is connected to an input port, wherein each of the plurality of the HDCP receivers is adapted to perform a first authentication part of a HDCP authentication process, and upon reception of an indication that a respective source device connected to the respective input was selected, to perform a third authentication part of the HDCP authentication process.

2. The apparatus of claim 1, is further connected to a multimedia sink device.

3. The apparatus of claim 2, wherein performing the first authentication part further comprising: performing a second authentication part of the HDCP authentication process when the multimedia sink device is a repeater.

4. The apparatus of claim 1, wherein the high bandwidth multimedia interface comprises any of a high-definition multimedia interface (HDMI), a digital visual interface (DVI), and a DisplayPort.

5. The apparatus of claim 1, wherein the HDCP receiver asserts a hot-plug detected (HPD) signal prior to performing the first part of the authentication.

6. The apparatus of claim 5, prior to performing the third authentication part further comprising;
performing a check if a selected indication was received after completion of the first authentication part;
de-asserting the HPD signal when the selected indication was not received; and
asserting the HPD signal.

7. The apparatus of claim 6, further comprising:
waiting a predefined amount of time between the de-assertion and assertion of the HPD signal.

8. The apparatus of claim 1, wherein each of the plurality of HDCP receivers comprises an inter-integrated circuit (I2C) suspend mechanism to control the pace of performing the first authentication part, wherein the I2C suspend mechanism is activated when the first part of the HDCP authentication process is nearly completed.

9. The apparatus of claim 1, wherein each of the plurality of HDCP receivers accesses a memory at a specific time slot to retrieve any of enhanced extended display identification data (E-EDID) information and device key selection (DKS) information.

10. The apparatus of claim 9, wherein the time slots allocated for the HDCP receivers have the same duration of time.

11. The apparatus of claim 9, wherein the time slots allocated for the HDCP receivers are non-overlapping.

12. The apparatus of claim 9, wherein the time slots allocated for each HDCP receiver are periodically repeated.

13. A method for fast switching between a plurality of source multimedia devices connected to a sink multimedia device through a high bandwidth multimedia interface, wherein the method is performed by a HDCP receiver connected to the sink multimedia device, comprising:
asserting a hot-plug detected (HPD) signal;
performing a first authentication part of a high-bandwidth digital content protection (HDCP) authentication process; and
upon reception of an indication that a source multimedia device connected to the HDCP receiver was selected, performing a third authentication part of the HDCP authentication process.

14. The method of claim 13, further comprising;
performing a check if the selected indication was received after completion of the first authentication part;
de-asserting the HPD signal when the selected indication was not received; and
asserting the HPD signal.

15. The method of claim 14, further comprising:
waiting a predefined amount of time between the de-assertion and assertion of the HPD signal.

16. The method of claim 14, wherein the de-assertion of the HPD signal causes a HDCP transmitter to terminate the HDCP authentication process.

17. The method of claim 14, wherein performing the first authentication part further comprising:
performing a second authentication part of the HDCP authentication process when the multimedia sink device is a repeater.

18. The method of claim 13, wherein the high bandwidth multimedia interface comprises any of a high-definition multimedia interface (HDMI), a digital visual interface (DVI), and a DisplayPort.

19. A computer readable medium having stored thereof computer executable code when executed by a multimedia sink performs the process of fast switching between a plurality of source multimedia devices connected to a sink multimedia device through a high bandwidth multimedia interface, wherein the method is performed by HDCP receiver connected to the sink multimedia device, comprising:
asserting a hot-plug detected (HPD) signal;
performing a first authentication part of a high-bandwidth digital content protection (HDCP) authentication process; and
upon reception of an indication that a source multimedia device connected to the HDCP receiver was selected, performing a third authentication part of the HDCP authentication process.

20. The computer readable medium of claim 19, further comprising;
performing a check if the selected indication was received after completion of the first authentication part;
de-asserting the HPD signal when the selected indication was not received; and
asserting the HPD signal.
